(19) United States
(12) Patent Application Publication
(10) Pub. No.: US 2025/0104478 A1
(43) Pub. Date: Mar. 27, 2025

(54) INTERACTION PROCESSING METHOD AND APPARATUS

(71) Applicant: Alipay (Hangzhou) Information Technology Co., Ltd., Hangzhou (CN)

(72) Inventors: Yingbo WANG, Hangzhou (CN); Congyang PENG, Hangzhou (CN)

(21) Appl. No.: 18/971,903

(22) Filed: Dec. 6, 2024

Related U.S. Application Data
(63) Continuation of application No. PCT/CN2023/108712, filed on Jul. 21, 2023.

(30) Foreign Application Priority Data
Oct. 14, 2022 (CN) 202211262136.0

(51) Int. Cl. G06V 40/20; G06T 7/20; G06T 7/50; G06V 20/70; G06V 40/12

(52) U.S. Cl. CPC G06V 40/28; G06T 7/20; G06T 7/50; G06V 20/70; G06V 40/12; G06T 2207/20081; G06T 2207/30241; G06V 2201/07

(57) ABSTRACT

An interaction processing method includes: receiving a dynamic image of a gesture move of a user; performing gesture recognition on the dynamic image to obtain gesture recognition result image data of the dynamic image; performing object detection based on the image data, to determine a hand shape change and a gesture motion trajectory of the user; determining, based on the hand shape change and the gesture motion trajectory, a corresponding gesture and an instruction mapped to the gesture; and executing the instruction.

### CROSS-REFERENCE TO RELATED APPLICATIONS

This application is a continuation application of International Application No. PCT/CN2023/108712, filed Jul. 21, 2023, which claims priority to Chinese Patent Application No. 202211262136.0, filed on Oct. 14, 2022, the entire contents of both of which are incorporated herein by reference.

### TECHNICAL FIELD

This application relates to the technical field of virtual reality, and in particular, to an interaction processing method and apparatus.

### BACKGROUND

As the concept of “metaverse” heats up and virtual reality (VR) and augmented reality (AR) application scenarios rapidly increase, human-machine interaction in VR, AR and mixed reality (MR) has become a very important module. How to implement human-machine interaction is a significant challenge to related software and hardware. Currently, most interactions are implemented by hardware, for example, an VR headset plus a joystick/an all-in-one VR headset. Interaction with a game system is performed using the headset and the joystick.

However, the inconvenience of wearing the device and obscuring of the vision can cause great inconvenience to a user. In addition, a dedicated device is required to complete interaction, making human-machine interaction too device-dependent and costly. Moreover, the interaction manner is fixed, and interaction can be completed only by clicking on a mechanical button or making a fixed action, resulting in a poor user experience.

### SUMMARY

According to a first aspect, an interaction processing method includes: receiving a dynamic image of a gesture move of a user; performing gesture recognition on the dynamic image to obtain gesture recognition result image data of the dynamic image; performing object detection based on the gesture recognition result image data, to determine a hand shape change and a gesture motion trajectory of the user; determining, based on the hand shape change and the gesture motion trajectory, a gesture corresponding to the hand shape change and the gesture motion trajectory and an instruction mapped to the gesture; and executing the instruction.

According to a second aspect, an interaction processing apparatus includes: a processor; and a memory storing instructions executable by the processor, wherein the processor is configured to: receive a dynamic image of a gesture move of a user; perform gesture recognition on the dynamic image to obtain gesture recognition result image data of the dynamic image; perform object detection based on the gesture recognition result image data, to determine a hand shape change and a gesture motion trajectory of the user; determine, based on the hand shape change and the gesture motion trajectory, a gesture corresponding to the hand shape change and the gesture motion trajectory and an instruction mapped to the gesture; and execute the instruction.

### BRIEF DESCRIPTION OF DRAWINGS

The following is a brief description of the accompanying drawings.

FIG. 1 is a flowchart of an interaction processing method, according to an embodiment.

FIG. 2 is a flowchart of an interaction processing method, according to an embodiment.

FIG. 3 is an example diagram of a gesture image annotated with a hand area and hand landmarks, according to an embodiment.

FIG. 4 is a flowchart of an interaction processing method, according to an embodiment.

FIG. 5 is a flowchart of an implementation process of obtaining gesture recognition result image data, according to an embodiment.

FIG. 6 is a flowchart of an interaction processing method, according to another embodiment.

FIG. 7 is a flowchart of an interaction processing method, according to yet an embodiment.

FIG. 8 is a schematic diagram of an interaction processing apparatus, according to an embodiment.

FIG. 9 is a schematic diagram of an interaction processing apparatus, according to an embodiment.

### DETAILED DESCRIPTION OF EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The described embodiments are merely examples rather than all the embodiments of the present disclosure.

The term “exemplary” specially used herein means “as an example, embodiment, or illustrative”. Any embodiment described herein as “exemplary” should not be construed as being superior to or better than other embodiments. Although various aspects of the embodiments are shown in the accompanying drawings, the accompanying drawings are not necessarily drawn to scale, unless otherwise indicated.

In addition, the technical features described below in different implementations of this application may be mutually combined as long as they do not constitute a conflict with each other.

Before the embodiments of this disclosure are described, related technical terms are first described.

Object detection: A mathematical model established based on a network structure (nodes and edges). Object detection is also a very basic task in many technical fields of computer vision. Image segmentation, object tracking, landmark detection, and the like generally depend on object detection.

Image augmentation: A series of random changes are made to a training image, so as to generate similar but different training samples, thereby increasing the size of a training data set.

Gesture recognition: An interactive technology belonging to computer science and linguistics that analyzes, determines, and integrates human gestures using mathematical algorithms based on what people want to express.

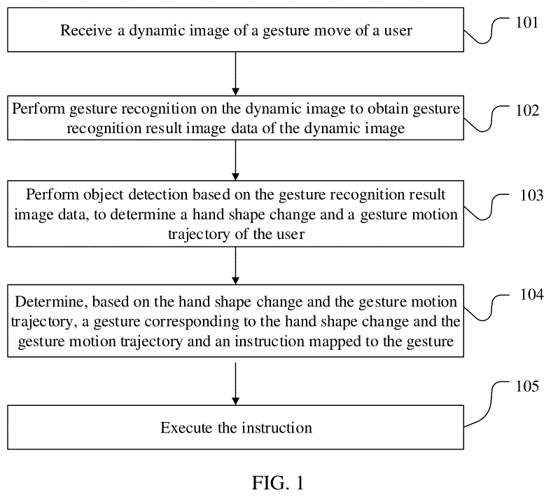

Embodiments of this disclosure provide an interaction processing method, so as to reduce interaction costs and improve user experience. FIG. 1 is a flowchart of an interaction processing method, according to an embodiment. As shown in FIG. 1, the method includes the following steps.

Step 101: Receive a dynamic image of a gesture move of a user.

In an embodiment, a video of the gesture move of the user is taken using an optical camera of a lightweight device such as a mobile phone or a tablet computer, so as to acquire and receive the dynamic image of the gesture move of the user.

Step 102: Perform gesture recognition on the dynamic image to obtain gesture recognition result image data of the dynamic image.

In an embodiment, the dynamic image may be analyzed by using a gesture recognition model or algorithm, to obtain the gesture recognition result image data of the dynamic image.

In an embodiment, to avoid an image acquisition error caused by improper image acquisition or the device not being placed at a right angle or the like, it is desirable to improve as much as possible accuracy of gesture recognition, and the provided interaction processing method further includes: performing image transformation preprocessing on the dynamic image to obtain a processed dynamic image. The image transformation is an adjustment made for adapting to camera shooting, for example, left-right inversion after mirrored shooting of the camera, or angle correction after tilted shooting of the camera. Those skilled in the art may understand that the above two preprocessing manners are merely examples, and are not used to limit the scope of protection of this disclosure.

Further, the gesture recognition may be implemented by using a gesture recognition model, and the gesture recognition is performed on the dynamic image to obtain the gesture recognition result image data of the dynamic image. For example, a process includes: inputting the processed dynamic image into the gesture recognition model to obtain the gesture recognition result image data. In an embodiment, the gesture recognition model is pre-established to perform palm recognition and palm landmark position recognition on an input image to obtain a gesture recognition result.

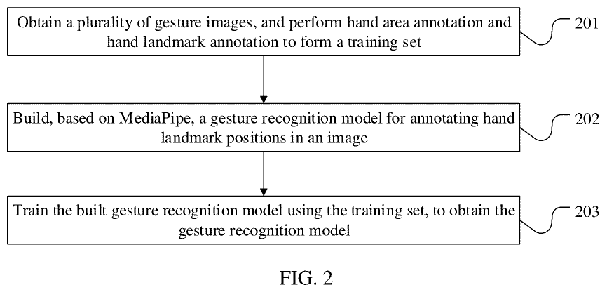

FIG. 2 is a flowchart of an interaction processing method, according to an embodiment. As shown in FIG. 2, the interaction processing method further includes: step 201: obtaining a plurality of gesture images, and performing hand area annotation and hand landmark annotation to form a training set; step 202: building, based on MediaPipe, a gesture recognition model for annotating hand landmark positions in an image; and step 203: training the built gesture recognition model using the training set, to obtain the gesture recognition model.

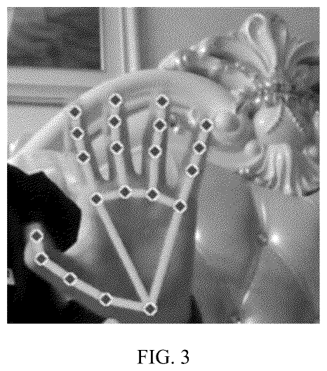

The plurality of gesture images are gesture images actually taken in a real background. In each gesture image, a hand outline is defined, a hand area is discriminated and annotated, and hand landmarks are annotated in the hand area. For example, 21 joint coordinates are annotated, as shown in FIG. 3, which is a gesture image annotated with a hand area and hand landmarks in an embodiment.

MediaPipe is an open-source project that can be used to build a cross-platform, multi-modal (ML) pipeline framework and that consists of fast ML inference, traditional computer vision, and media processing (such as video decoding). With MediaPipe, the gesture recognition model for annotating hand landmark positions in an image is built. The model includes two sub-models. The first sub-model, referred to herein as BlazePalm, defines the hand outline from the entire image and find the position of the hand, with an average detection accuracy of 95.7%. The second sub-model is, referred to herein as Hand Landmark. After the first sub-model finds the palm, the second sub-model is responsible for locating the landmarks. It can find 21 joint coordinates on the palm and returns a 2.5D (a perspective between 2D and 3D) result. Then, the built gesture recognition model is trained using the training set formed in step 201, to obtain the gesture recognition model.

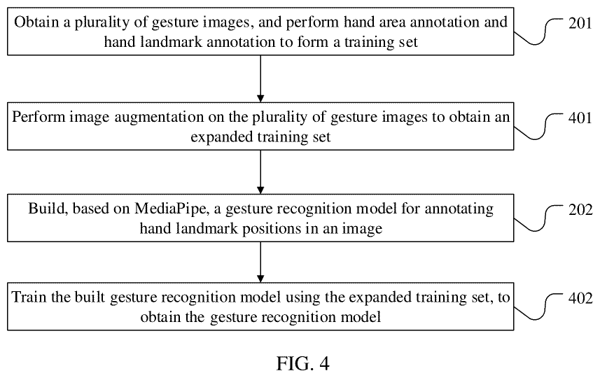

In an embodiment, to improve applicability of the model such that the model is still applicable and can accurately recognize gestures after the background is changed, an interaction processing method is illustrated shown in FIG. 4. Referring to FIG. 4, based on FIG. 2, the interaction processing method further includes: step 401: performing image augmentation on the plurality of gesture images to obtain an expanded training set; and step 402: training the built gesture recognition model using the expanded training set, to obtain the gesture recognition model. Step 402 corresponds to step 203 in FIG. 2.

In an implementation of step 401, the original real background in the gesture image is replaced with a synthetic background, and the synthetic background may be determined according to use scenarios. To maximize recognition accuracy of the trained gesture recognition model, types and a quantity of synthetic backgrounds are increased as much as possible.

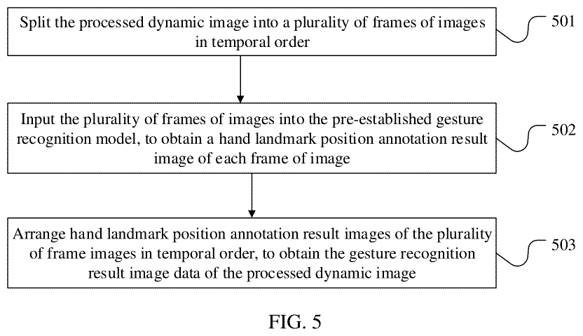

In an embodiment, after the gesture recognition model is pre-established, the inputting the processed dynamic image into the gesture recognition model to obtain the gesture recognition result image data, as shown in FIG. 5, includes: step 501: splitting the processed dynamic image into a plurality of frames of images in temporal order; step 502: inputting the plurality of frames of images into the pre-established gesture recognition model, to obtain a hand landmark position annotation result image of each frame of image; and step 503: arranging hand landmark position annotation result images of the plurality of frame images in temporal order, to obtain the gesture recognition result image data of the processed dynamic image.

Since the gesture recognition model recognizes a single picture during image recognition, the dynamic image is split into frames of still images in temporal order of shooting, which are then input into the gesture recognition model. After a hand landmark position annotation result image of each frame of image is obtained, the hand landmark position annotation result images are also arranged in temporal order of shooting, to obtain the gesture recognition result image data of the processed dynamic image.

Referring back to FIG. 1, Step 103: Perform object detection based on the gesture recognition result image data, to determine a hand shape change and a gesture motion trajectory of the user, after the gesture recognition result image data of the dynamic image is obtained. The hand shape change refers to a change in the posture and shape of a hand, for example, a palm turning into a first shape, bending fingers, stretching fingers, a spider-man web-shooting gesture, or a Super 6+1 gesture. The gesture motion refers to a motion of a hand in space, for example, wave-like forward movement, touching with an open palm in the air, or a Catholic prayer gesture of making a sign of the Cross.

According to the temporal order, except for an absolute still gesture, a hand shape and/or a gesture position in an image changes inevitably; that is, a gesture changes. A hand shape change and a gesture motion trajectory of the user can be determined by using object detection. In an embodiment, an object detection module may be used to perform dynamic detection on the input gesture recognition result image data, where the object detection module may be established based on a model such as YOLO V5 (PC end), YOLOX (mobile end), or Anchor-free.

In an embodiment, for a better subsequent comparison of the hand shape change and the gesture motion trajectory, OpenCV (an open-source computer vision library) may be used to perform regression on the hand shape change and the gesture motion trajectory, simplifying into the change and the motion trajectory of the 21 hand landmarks, for example.

Further, a gesture change is a continuous process, and only a few key moments are required to determine the change process. Therefore, it is not necessary to input all frames of the gesture recognition result image data into the object detection model, which causes an excessive data processing amount and a waste of computing resources. In an embodiment, before step 103 is implemented, the interaction processing method further includes: performing sampling on the gesture recognition result image data through frame extraction, to obtain sampled gesture recognition result image data. The frame extraction refers to extracting a few frames at key moments from a plurality of frames of images. In an implementation, one frame is generally extracted every a preset number of frames or every a preset time period. For example, one frame may be extracted every 100 ms, so as to not only ensure that the hand change can be detected, but also reduce an image processing amount and increase the detection speed.

Step 104: Determine, based on the hand shape change and the gesture motion trajectory, a gesture corresponding to the hand shape change and the gesture motion trajectory and an instruction mapped to the gesture, after the hand shape change and the gesture motion trajectory of the user are determined.

In an implementation of step 104, a gesture may be fixed for the user in advance. For example, the gesture of applause is an instruction to click on an item, and waving a hand is an exit instruction, and so on. The user makes a corresponding gesture move according to a prompt. After a hand shape change and a gesture motion trajectory of the user are determined, the gesture and the instruction corresponding to this gesture can be determined, so that the instruction can be executed and an instruction execution result can be fed back to the user.

In an embodiment, to further add interaction manners and give more choices to the user, without limiting to the fixed gestures, the user can preset different customized gestures in advance to correspond to different instructions. Therefore, in this embodiment, an implementation process of step 104 includes: searching a pre-established gesture library to determine the gesture corresponding to the hand shape change and the gesture motion trajectory and the instruction mapped to the gesture, where the gesture library records an association relationship between a gesture identifier, a hand shape change and a gesture motion trajectory corresponding to a gesture, and an instruction mapped to a gesture.

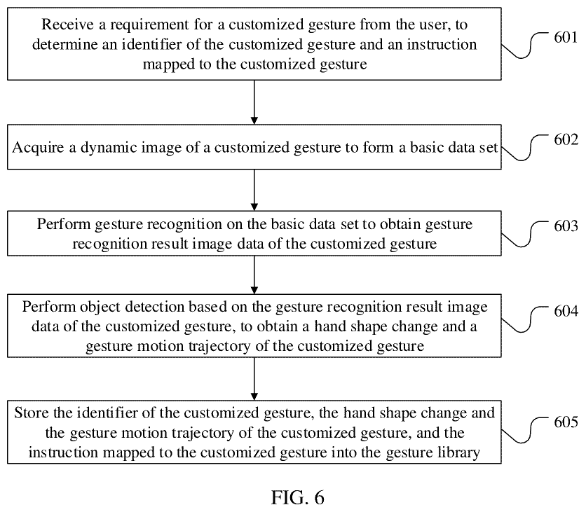

In this embodiment, the user records a gesture in advance, and store the gesture in the gesture library. Therefore, the interaction processing method shown in FIG. 6 further includes: step 601: receiving a requirement for a customized gesture from the user, to determine an identifier of the customized gesture and an instruction mapped to the customized gesture; step 602: acquiring a dynamic image of a customized gesture to form a basic data set; step 603: performing gesture recognition on the basic data set to obtain gesture recognition result image data of the customized gesture; step 604: performing object detection based on the gesture recognition result image data of the customized gesture, to obtain a hand shape change and a gesture motion trajectory of the customized gesture; and step 605: storing the identifier of the customized gesture, the hand shape change and the gesture motion trajectory of the customized gesture, and the instruction mapped to the customized gesture into the gesture library.

The requirement for the customized gesture of the user refers to an expectation of the user for an instruction that the customized gesture corresponds to, as well as naming of the customized gesture. The identifier of the customized gesture is usually named by the user. If the user does not provide a name, or to avoid confusion, the identifier of the customized gesture may be numbered according to a recording sequence, and the number is used as the identifier of the customized gesture. For example, for the first recorded customized gesture, an identifier of the customized gesture is 0001.

In an implementation, to avoid an error caused by a non-standard acquisition action, dynamic images of the customized gesture are acquired in multiple times, with the dynamic image acquired each time forming a temporal image set; and an intersection of a plurality of temporal image sets is calculated to obtain the basic data set. That is, the customized gesture move of the user is acquired for multiple times, and is split into temporal image sets frame by frame in temporal order, and then an intersection of the plurality of temporal image sets acquired multiple times is calculated. Only the images containing the gesture at all times are recorded to form the basic data set, so as to avoid an extra gesture being recorded during a single acquisition, causing an inability to accurately match subsequently.

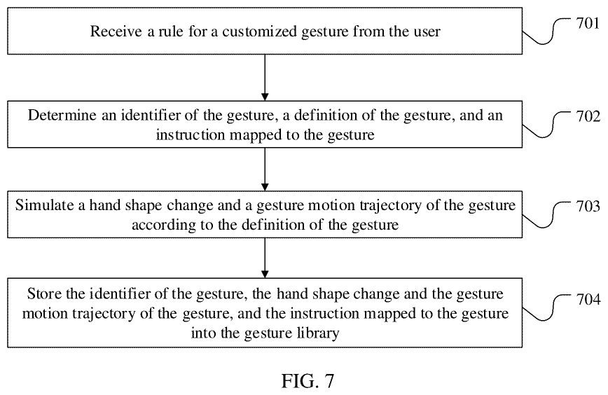

In another embodiment, to meet diverse requirements of the user, it is desired to specify a mapping between a gesture and an instruction by rule formulation as a reference for subsequent matching, when the user cannot or does not want to record a customized gesture move in advance. An interaction processing method shown in FIG. 7 further includes: step 701: receiving a rule for a customized gesture from the user; step 702: determining, according to the rule, an identifier of the gesture, a definition of the gesture, and an instruction mapped to the gesture; step 703: simulating a hand shape change and a gesture motion trajectory of the gesture according to the definition of the gesture; and step 704: storing the identifier of the gesture, the hand shape change and the gesture motion trajectory of the gesture, and the instruction mapped to the gesture into the gesture library.

The rule for the customized gesture of the user is a description of the customized gesture. For example, common gestures may be described using well-known gesture names, such as a peace sign, applause, hand clapping, and first making. Uncommon gestures need to be defined using clear language, such as waving the palm in a wave-like motion while moving forward, making a first and then extending the knuckle of the index finger, and extending the index finger and moving the entire hand horizontally. The above definitions translated into constraints on one or more of the 21 landmarks of the fingers, simulating the hand shape change and gesture motion trajectory of the gesture.

In an implementation, the gesture library may be configured locally, or may be configured in the cloud for easier use. During storage, a “key-value” manner is generally used for storage, with a corresponding instruction used as a key, and a gesture identifier, change characteristics of the 21 landmarks of a hand shape, and characteristics of a gesture motion used as a value.

Step 105: Execute the instruction.

After the gesture corresponding to the hand shape change and the gesture motion trajectory and the instruction mapped to the gesture are determined based on the hand shape change and the gesture motion trajectory, the instruction is executed, and a result of the instruction execution is returned to a client, so that the user knows the interaction result.

According to the interaction processing method provided in this embodiment, a dynamic image of a gesture move of a user is received; gesture recognition is performed on the dynamic image to obtain gesture recognition result image data of the dynamic image; object detection is performed based on the gesture recognition result image data, to determine a hand shape change and a gesture motion trajectory of the user; a gesture corresponding to the hand shape change and the gesture motion trajectory and an instruction mapped to the gesture are determined based on the hand shape change and the gesture motion trajectory; and the instruction is executed. Gesture recognition and object detection are performed on a dynamic image that is uploaded by a user and that contains a gesture move, so as to determine a hand shape change and a gesture motion trajectory of the user, and determine an instruction mapped to the gesture, that is, an instruction represented by the current gesture of the user; and then the instruction is executed to complete interaction. Compared with the related art, the interaction processing method provided in this embodiment does not require a dedicated device, but requires only a device including an optical camera, for example, a lightweight device such as a mobile phone, thereby reducing interaction costs. In addition, gestures can be changed, and interaction manners are diverse, thereby improving user experience.

In an interactive game example, a “summoner” controlled by a user and an in-game “pet” share a close emotional bond. The interaction process between the “pet” and the “summoner” also deepens the connection between each other, and enhances love and dependence of the “summoner” on the “pet”, thereby increasing user engagement.

Currently, interaction methods include clicking on a button of a wearable device to select different interaction instructions or voice control interaction. However, both interaction modes are too conventional to attract users, and the wearable device is expensive, which is not conducive to product promotion. With the aid of the interaction processing method provided in the embodiments of this disclosure, this specific example provides a new interaction form: using an optical camera (for example, a mobile phone's front camera) to detect a position of a hand of the “summoner” and recognize gestures for dynamic interaction.

Some common gestures may be preset and displayed to the user, and the user directly makes corresponding gestures, so as to interact with the “pet” on the screen. Alternatively, the user may design interactive gestures, record and acquire a video in advance or upload a customization rule that includes gesture detailed descriptions, which are then received and processed by the backend operation. The instruction that the user wishes to replace and the corresponding hand shape change and motion trajectory are determined and then stored in the gesture library, so that recognition and detection is performed after the user makes the corresponding gesture. For example, the user may pre-submit a “finger heart” gesture, customizing it by crossing their index finger and thumb to form an angle between 30 to 50 degrees. This gesture is named “finger heart” and is used to replace the instruction to reward the “pet”. A gesture move video of patting is pre-recorded 3 to 4 times and then uploaded to the platform. The platform compares the multiple recordings to determine a temporal image in each video, forming a basic data set of the customized gesture. After performing gesture recognition and object detection, the platform obtains a hand shape change and a gesture motion trajectory of the customized gesture. The user names the gesture as patting, and assigns this gesture as an interaction instruction of patting. The platform stores the hand shape change and the gesture motion trajectory of the customized gesture, the name of patting, and the mapped interaction instruction in a customized gesture database under the user's name. Similarly, the user may pre-record instruction gestures such as tickling, feeding, and hugging.

After logging in to the interactive game, the user may make a corresponding gesture. After acquiring the video of the gesture by using the camera of the mobile phone, the platform matches and determines an instruction in the gesture library to determine an interaction requirement that the user wants, so as to give an instruction such as patting, tickling, or feeding to the “pet”. The “pet” gives a corresponding feedback to the “summoner”, thereby completing the interaction process.

In this process, the user can interact with the “pet” only using the mobile phone. In addition, the user can select from multiple interaction modes, providing the user with enough novelty, increasing user engagement, and improving user experience.

In the interaction processing method provided in the above embodiment, only an optical camera is required to capture a gesture move of the user, and gesture recognition and object detection are performed on the gesture move of the user, to obtain a hand shape change and a gesture motion trajectory of the user. Based on a gesture library that stores a customized gesture captured in advance or defined in a rule by the user and a mapped instruction, an instruction mapped to the current gesture of the user can be determined, and the instruction can be executed to complete the interaction process. Only an optical camera is required, without the need for a specialized wearable device or reliance on devices. This eliminates issues such as difficulty in wearing, high costs, and the limitation of only being usable with VR headsets and joysticks. Based on service scenario requirements, users can customize complex gesture moves and interaction methods, not limited to fixed interaction forms. By using object detection and trajectory matching, it can recognize complex continuous dynamic gestures (such as patting, hitting, and long continuous actions), solving the problem of wearable devices' mechanical buttons that can only be clicked and cannot recognize dynamic actions.

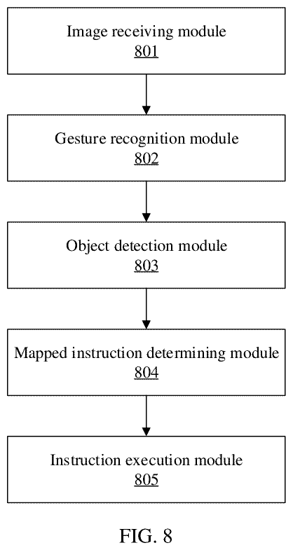

FIG. 8 is a schematic diagram of an interaction processing apparatus, according to an embodiment. As shown in FIG. 8, the apparatus includes: an image receiving module 801, configured to receive a dynamic image of a gesture move of a user; a gesture recognition module 802, configured to perform gesture recognition on the dynamic image to obtain gesture recognition result image data of the dynamic image; an object detection module 803, configured to perform object detection based on the gesture recognition result image data, to determine a hand shape change and a gesture motion trajectory of the user; a mapped instruction determining module 804, configured to determine, based on the hand shape change and the gesture motion trajectory, a gesture corresponding to the hand shape change and the gesture motion trajectory and an instruction mapped to the gesture; and an instruction execution module 805, configured to execute the instruction.

In an embodiment, to reduce an error and improve recognition and detection accuracy, the interaction processing apparatus further includes: a preprocessing module, configured to perform image transformation preprocessing on the dynamic image to obtain a processed dynamic image. Correspondingly, the gesture recognition module is configured to input the processed dynamic image into a gesture recognition model to obtain the gesture recognition result image data.

The gesture recognition model is pre-established to perform palm recognition and palm landmark position recognition on an input image to obtain a gesture recognition result.

In an embodiment, the interaction processing apparatus further includes a recognition model pre-establishment module, configured to: obtain a plurality of gesture images, and perform hand area annotation and hand landmark annotation to form a training set; build, based on MediaPipe, a gesture recognition model for annotating hand landmark positions in an image; and train the built gesture recognition model using the training set, to obtain the gesture recognition model.

To improve applicability of the gesture recognition model, the recognition model pre-establishment module is further configured to: perform image augmentation on the plurality of gesture images to obtain an expanded training set; and train the built gesture recognition model using the expanded training set, to obtain the gesture recognition model.

In an implementation, the recognition model pre-establishment module is configured to: split the processed dynamic image into a plurality of frames of images in temporal order; input the plurality of frames of images into the pre-established gesture recognition model, to obtain a hand landmark position annotation result image of each frame of image; and arrange hand landmark position annotation result images of the plurality of frame images in temporal order, to obtain the gesture recognition result image data of the dynamic image.

In an embodiment, to reduce an image processing amount and save computing resources, the interaction processing apparatus provided further includes an image sampling module, configured to perform sampling on the gesture recognition result image data through frame extraction, to obtain sampled gesture recognition result image data.

Correspondingly, the object detection module is configured to input the sampled gesture recognition result image data into an object detection model, to determine the hand shape change and the gesture motion trajectory of the user.

In an embodiment, the mapped instruction determining module 804 is configured to searching a pre-established gesture library to determine the gesture corresponding to the hand shape change and the gesture motion trajectory and the instruction mapped to the gesture, where the gesture library records an association relationship between a gesture identifier, a hand shape change and a gesture motion trajectory corresponding to a gesture, and an instruction mapped to a gesture.

In an embodiment, the interaction processing apparatus further includes a first gesture customization module, configured to: receive a requirement for a customized gesture from the user, to determine an identifier of the customized gesture and an instruction mapped to the customized gesture; acquire a dynamic image of a customized gesture to form a basic data set; perform gesture recognition on the basic data set to obtain gesture recognition result image data of the customized gesture; perform object detection based on the gesture recognition result image data of the customized gesture, to obtain a hand shape change and a gesture motion trajectory of the customized gesture; and store the identifier of the customized gesture, the hand shape change and the gesture motion trajectory of the customized gesture, and the instruction mapped to the customized gesture into the gesture library.

For example, the first gesture customization module is configured to: acquire dynamic images of the customized gesture in multiple times, with the dynamic image acquired each time forming a temporal image set; and calculate an intersection of a plurality of temporal image sets to obtain the basic data set.

In an embodiment, the interaction processing apparatus further includes a second gesture customization module, configured to: receive a rule for a customized gesture from the user; determine an identifier of the gesture, a definition of the gesture, and an instruction mapped to the gesture; simulate a hand shape change and a gesture motion trajectory of the gesture according to the definition of the gesture; and store the identifier of the gesture, the hand shape change and the gesture motion trajectory of the gesture, and the instruction mapped to the gesture into the gesture library.

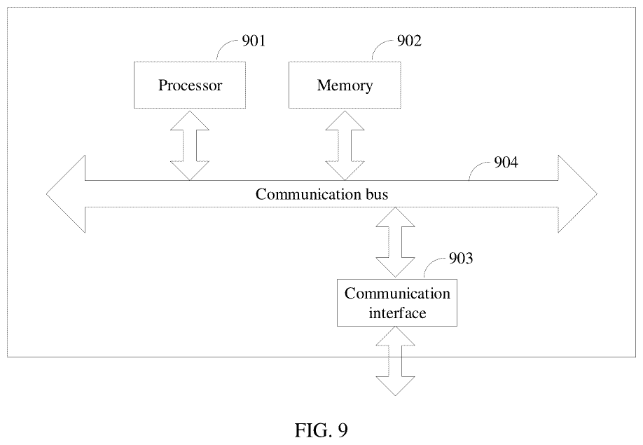

FIG. 9 is a schematic diagram of an interaction processing apparatus, according to an embodiment. The interaction processing apparatus includes the following: a processor 901, a memory 902, a communication interface 903, and a communication bus 904. The processor 901, the memory 902, and the communication interface 903 complete mutual communication through the communication bus 904. The communication interface 903 is configured to implement information transmission between related devices. The processor 901 is configured to call a computer program in the memory 902, and the processor, upon executing the computer program, implements the interaction processing method described above.

An embodiment of this disclosure further provides a non-transitory computer-readable storage medium storing a computer program, where in response to the computer program being executed by a processor, the operations of the above-described interaction processing method are implemented.

Although method operation steps are described in the embodiments or flowcharts, more or fewer operation steps may be included, based on conventional or non-inventive efforts. The sequence of the steps enumerated in the embodiments is only one of a plurality of step execution sequences, and does not represent the only execution sequence. An actual apparatus or client product may be executed in sequence or in parallel (e.g., a parallel processor or a multi-threaded processing environment) according to the method shown in the embodiments or the accompanying drawings.

Those skilled in the art should understand that each module in the described embodiments can be implemented by hardware, software, or a combination thereof. When the module is implemented by software, the software can be stored in a computer-readable medium or transmitted as one or more instructions to implement corresponding functions.

The embodiments are described with reference to flowcharts and block diagrams. It should be understood that computer program instructions may be used to implement an operation or a module in the flowcharts and the block diagrams. These computer program instructions may be provided to a processor of a general-purpose computer, a special-purpose computer, an embedded processor, or another programmable data processing device to generate a machine, such that the instructions executed by the processor of the computer or another programmable data processing device implement a specific function in the flowcharts and the block diagrams.

It should be understood that the above descriptions are merely example embodiments of the present disclosure, and are not intended to limit the protection scope of this disclosure. Any modification, equivalent replacement, improvement, etc. made based on the embodiments of this disclosure shall fall within the protection scope of this disclosure.

What is claimed is:

1. An interaction processing method, comprising:
receiving a dynamic image of a gesture move of a user;
performing gesture recognition on the dynamic image to obtain gesture recognition result image data of the dynamic image;
performing object detection based on the gesture recognition result image data, to determine a hand shape change and a gesture motion trajectory of the user;
determining, based on the hand shape change and the gesture motion trajectory, a gesture corresponding to the hand shape change and the gesture motion trajectory and an instruction mapped to the gesture; and
executing the instruction.

2. The interaction processing method according to claim 1, further comprising:
performing image transformation preprocessing on the dynamic image to obtain a processed dynamic image; and
the performing the gesture recognition on the dynamic image to obtain the gesture recognition result image data of the dynamic image comprises:
inputting the processed dynamic image into a gesture recognition model to obtain the gesture recognition result image data.

3. The interaction processing method according to claim 2, wherein the gesture recognition model is pre-established to perform palm recognition and palm landmark position recognition on an input image to obtain a gesture recognition result.

4. The interaction processing method according to claim 3, wherein pre-establishing the gesture recognition model comprises:
obtaining a plurality of gesture images, and performing hand area annotation and hand landmark annotation to form a training set;
building, based on MediaPipe, a gesture recognition model for annotating hand landmark positions in an image; and
training the built gesture recognition model using the training set, to obtain the trained gesture recognition model.

5. The interaction processing method according to claim 4, wherein pre-establishing the gesture recognition model further comprises:
performing image augmentation on the plurality of gesture images to obtain an expanded training set; and
the training the built gesture recognition model using the training set, to obtain the trained gesture recognition model comprises:
training the built gesture recognition model using the expanded training set, to obtain the trained gesture recognition model.

6. The interaction processing method according to claim 4, wherein the inputting the processed dynamic image into the gesture recognition model to obtain the gesture recognition result image data comprises:
splitting the processed dynamic image into a plurality of frames of images in temporal order;
inputting the plurality of frames of images into the pre-established gesture recognition model, to obtain a hand landmark position annotation result image of each frame of image; and
arranging hand landmark position annotation result images of the plurality of frame images in temporal order, to obtain the gesture recognition result image data of the processed dynamic image.

7. The interaction processing method according to claim 1, further comprising:
performing sampling on the gesture recognition result image data through frame extraction, to obtain sampled gesture recognition result image data; and
the performing the object detection based on the gesture recognition result image data, to determine the hand shape change and the gesture motion trajectory of the user comprises:
inputting the sampled gesture recognition result image data into an object detection model, to determine the hand shape change and the gesture motion trajectory of the user.

8. The interaction processing method according to claim 1, wherein the determining, based on the hand shape change and the gesture motion trajectory, the gesture corresponding to the hand shape change and the gesture motion trajectory and the instruction mapped to the gesture comprises:
searching a pre-established gesture library to determine the gesture corresponding to the hand shape change and the gesture motion trajectory and the instruction mapped to the gesture,
wherein the gesture library records an association relationship between a gesture identifier, a hand shape change and a gesture motion trajectory corresponding to a gesture, and an instruction mapped to a gesture.

9. The interaction processing method according to claim 8, further comprising:
receiving a requirement for a customized gesture from the user, to determine an identifier of the customized gesture and an instruction mapped to the customized gesture;
acquiring a dynamic image of a customized gesture to form a basic data set;
performing gesture recognition on the basic data set to obtain gesture recognition result image data of the customized gesture;
performing object detection based on the gesture recognition result image data of the customized gesture, to obtain a hand shape change and a gesture motion trajectory of the customized gesture; and
storing the identifier of the customized gesture, the hand shape change and the gesture motion trajectory of the customized gesture, and the instruction mapped to the customized gesture into the gesture library.

10. The interaction processing method according to claim 9, wherein the acquiring the dynamic image of the customized gesture to form the basic data set comprises:
acquiring dynamic images of the customized gesture multiple times, with the dynamic image acquired each time forming a temporal image set; and
calculating an intersection of a plurality of temporal image sets to obtain the basic data set.

11. The interaction processing method according to claim 8, further comprising:
receiving a rule for a customized gesture from the user;
determining, according to the rule, an identifier of the gesture, a definition of the gesture, and an instruction mapped to the gesture;
simulating a hand shape change and a gesture motion trajectory of the gesture according to the definition of the gesture; and
storing the identifier of the gesture, the hand shape change and the gesture motion trajectory of the gesture, and the instruction mapped to the gesture into the gesture library.

12. An interaction processing apparatus, comprising:
a processor; and
a memory storing instructions executable by the processor,
wherein the processor is configured to:
receive a dynamic image of a gesture move of a user;
perform gesture recognition on the dynamic image to obtain gesture recognition result image data of the dynamic image;
perform object detection based on the gesture recognition result image data, to determine a hand shape change and a gesture motion trajectory of the user;
determine, based on the hand shape change and the gesture motion trajectory, a gesture corresponding to the hand shape change and the gesture motion trajectory and an instruction mapped to the gesture; and
execute the instruction.

13. The interaction processing apparatus according to claim 12, wherein the processor is further configured to:
perform image transformation preprocessing on the dynamic image to obtain a processed dynamic image; and
input the processed dynamic image into a gesture recognition model to obtain the gesture recognition result image data.

14. The interaction processing apparatus according to claim 13, wherein the gesture recognition model is pre-established to perform palm recognition and palm landmark position recognition on an input image to obtain a gesture recognition result.

15. The interaction processing apparatus according to claim 14, wherein the processor is further configured to:
obtain a plurality of gesture images, and perform hand area annotation and hand landmark annotation to form a training set;
build, based on MediaPipe, a gesture recognition model for annotating hand landmark positions in an image; and
train the built gesture recognition model using the training set, to obtain the trained gesture recognition model.

16. The interaction processing apparatus according to claim 15, wherein the processor is further configured to:
perform image augmentation on the plurality of gesture images to obtain an expanded training set; and
train the built gesture recognition model using the expanded training set, to obtain the trained gesture recognition model.

17. The interaction processing apparatus according to claim 15, wherein the processor is further configured to:
split the processed dynamic image into a plurality of frames of images in temporal order;
input the plurality of frames of images into the pre-established gesture recognition model, to obtain a hand landmark position annotation result image of each frame of image; and
arrange hand landmark position annotation result images of the plurality of frame images in temporal order, to obtain the gesture recognition result image data of the dynamic image.

18. The interaction processing apparatus according to claim 12, wherein the processor is further configured to:
perform sampling on the gesture recognition result image data through frame extraction, to obtain sampled gesture recognition result image data; and
input the sampled gesture recognition result image data into an object detection model, to determine the hand shape change and the gesture motion trajectory of the user.

19. The interaction processing apparatus according to claim 12, wherein the processor is configured to:
search a pre-established gesture library to determine the gesture corresponding to the hand shape change and the gesture motion trajectory and the instruction mapped to the gesture,
wherein the gesture library records an association relationship between a gesture identifier, a hand shape change and a gesture motion trajectory corresponding to a gesture, and an instruction mapped to a gesture.

20. The interaction processing apparatus according to claim 19, further wherein the processor is further configured to:
receive a requirement for a customized gesture from the user, to determine an identifier of the customized gesture and an instruction mapped to the customized gesture;
acquire a dynamic image of a customized gesture to form a basic data set;
perform gesture recognition on the basic data set to obtain gesture recognition result image data of the customized gesture;
perform object detection based on the gesture recognition result image data of the customized gesture, to obtain a hand shape change and a gesture motion trajectory of the customized gesture; and
store the identifier of the customized gesture, the hand shape change and the gesture motion trajectory of the customized gesture, and the instruction mapped to the customized gesture into the gesture library.
